(19) United States
(12) Patent Application Publication
(10) Pub. No.: US 2026/0260150 A1
(43) Pub. Date: Sep. 3, 2026

(54) METHOD FOR SOLVING A COMPUTATION PROBLEM

(71) Applicant: Kipu Quantum GmbH, Karlsruhe (DE)

(72) Inventors: Eric Michon, Berlin (DE); Jan Trautmann, Heidelberg (DE); Qi Zhang, Berlin (DE); Sébastien Perseguers, Fribourg (CH); Narendra Narayana Hegade, Bengaluru (IN); Enrique Leonidas Solano Villanueva, Berlin (DE)

(73) Assignee: Kipu Quantum GmbH, Karlsruhe (DE)

(21) Appl. No.: 19/163,586

(22) PCT Filed: Mar. 11, 2024
(86) PCT No.: PCT/EP2024/056453

§ 371 Date: Sep. 9, 2025

(30) Foreign Application Priority Data
Mar. 9, 2023 (EP) 23160883.7

(51) Int. Cl. G06N 10/60; G06N 10/20; G06N 10/40

(52) U.S. Cl. CPC G06N 10/60; G06N 10/20; G06N 10/40

(57) ABSTRACT

The invention relates to a computer-implemented method, to a computer program and to a computer device as described herein. In particular, t invention relates to a computer-implemented method for solving a computation problem, in comprising the use of an Ising spin-glass Hamiltonian in the form (Formula (I)), wherein (Formula (II)), Ω is the Rabi frequency of the transition and can be dynamically controlled by controlling the power of one of the coupling laser, Δ corresponds to the detuning with regards to the two-photon transition and can also easily be changed dynamically, and the term containing J is the interactions term implemented via a Rydberg blockade mechanism and can optionally be rendered site-dependent or can be dynamically tuned, wherein the problem is solved by finding the solution for the Hamiltonian.

$${H}_{R y d} = Ω ( t ) {\sum }_{i} {σ}_{i}^{x} - Δ ( t ) {\sum }_{i} {n}_{j} + J {\sum }_{i , j} {n}_{i} {n}_{j} \qquad ( I )$$

$${n}_{𝔦} = ( 1 - {σ}_{t}^{z} ) / 2 \qquad ( II )$$

### CROSS-REFERENCE TO RELATED APPLICATIONS

This application claims priority to European patent application 23160883.7, filed Mar. 9, 2023, the disclosures of which is incorporated by reference herein in its entirety.

### TECHNICAL FIELD

The invention relates to quantum computing. Specifically, the invention is defined by the appended independent claims. Embodiments of the invention are defined in the dependent claims.

The invention also relates to a method and to a computer-implemented method, in particular to a method for solving a computation problem such as a combinatorial optimization problem on a computer with neutral atoms or trapped ions. In particular embodiments, the method is based on digital-analog counterdiabatic quantum computing (DACQC). In other embodiments, the method is based on analog counterdiabatic quantum computing (ACQC).

### DESCRIPTION OF THE INVENTION

In digital-analog quantum computing (DAQC), a given system typically uses a hybrid approach that combines time-independent digital blocks with time-dependent analog blocks (multi-qubit operations). The digital blocks consist of sequences of quantum gates that are applied at discrete times and are generally not time-dependent, meaning that once set, they apply a specific transformation that does not change over time. These digital blocks are used for precise quantum state manipulation.

Digital-analog counterdiabatic quantum computing (DACQC) performs a digital-analog implementation of the counterdiabatic quantum algorithm by using analog blocks (i.e. natural dynamics of the quantum computer) as a resource along with digital gates to enhance the efficiency of solving problems using quantum computers.

An analog quantum computer utilizes quantum computing to simulate complex systems directly, performing calculations through continuous-time evolution rather than discrete operations, often targeting specific problems like quantum simulation, optimization, or certain types of differential equations.

Rydberg qubits: Neutral atoms set-ups have been used for years now as a truly versatile experimental platform for quantum simulation. The shift in interest from quantum simulation to quantum computation with industrial applications in mind followed with the recent technological developments for trapping and manipulating arrays of single atoms led to the use of neutral atoms platforms to perform analog quantum computing. One of the most commonly used atomic species for quantum computation is rubidium-87 due to its well know electronic structure as well as the availability of the lasers and other hardware necessary.

Another important element to realize quantum computation with neutral atoms is the use of Rydberg states. Rydberg states are electronic states of an atom which has high quantum number, thus where the outer shell electron is promoted far away from the atomic core. This yields long range interactions with neighboring atoms. There are different ways to exploit Rydberg states that yields different spin state mapping scheme for neutral atoms platforms.

Optical tweezers are far-off resonance laser beams used to trap single atoms in space and reorganize them into any 2-dimensional or 3-dimensional patterns. Cooled down atomic clouds, Rydberg states and optical tweezers constitutes important parts of most neutral atoms quantum computation platforms.

A two spin states mapping scheme is described here as an example of the invention.

### Ground—Rydberg Qubits:

An atom which outer shell electron is promoted to a Rydberg state will interact with a neighboring atom in its natural ground state through a Van der Waals interaction. This interaction creates the Rydberg blockade phenomenon which prevents two neighboring atoms to be excited both in the Rydberg state creating quantum logic which is exploited on neutral atoms platform to recreate an Ising spin-glass Hamiltonian:

$$\frac{{H}_{R y d} ( t )}{h} = \frac{Ω ( t )}{2} {\sum }_{i} \{ cos [ ϕ ( t ) ] {σ}_{i}^{x} - sin [ ϕ ( t ) ] {σ}_{i}^{y} \} - Δ ( t ) {\sum }_{i} {n}_{i} + {\sum }_{i < j} {J}_{i j} {n}_{i} {n}_{j} \qquad ( 1 )$$

where

$${n}_{i} = ( 1 - {σ}_{i}^{z} ) / 2 ,$$

σ^{x} and σ^{z} the spin states Pauli matrices. This is achieved by shining lasers coupling through a two-photon transition the electronic ground state to the Rydberg state. Here, Ω is the Rabi frequency of the transition and can be dynamically controlled by controlling the power of one of the coupling lasers, Δ corresponds to the detuning with regards to the two-photon transition and can also be changed dynamically, φ is the phase of the driving field and only the relative phase between applied pulses matters for the axis of rotation. The term containing J is the interactions term implemented via the Rydberg blockade mechanism and decays with the distance between the two interacting atoms. It can be rendered site-dependent as well as can be dynamically tuned to a certain extent.

This is the most common spin state mapping scheme used by neutral atoms hardware companies as it is one of the easiest experimentally to implement and control and because of the shape of the native Hamiltonian, Ising spin-glass, onto which many industry-relevant problems can be encoded.

### Quantum Optimization Algorithms:

Quantum optimization algorithms are quantum algorithms that are used to solve optimization problems. A combinatorial optimization problem refers to the problem of finding the most efficient solution from a finite set of possibilities that satisfies certain criteria and constraints, often involving discrete or combinatorial structures like graphs, sequences, or configurations.

The framework used to compute problems on an analog quantum computer is the adiabatic computing and quantum annealing. For adiabatic quantum computing, one starts from a Hamiltonian which has a trivial ground state and evolves the system towards a Hamiltonian which has the solution of the computation problem as its ground state. The evolution should be adiabatic which yields very long computation times. This is limited by the coherence time of the system which does not allow complete adiabatic evolution. In the case of neutral hardware, the computation of combinatorial optimization can only be done with a non-adiabatic evolution between the initial Hamiltonian and the problem (the final) Hamiltonian. This leads to possible excitations in the energy spectrum and can yield the wrong final state, in other words the wrong solution of the problem. To circumvent that one can optimize the time dependent function with which the system changes from the initial Hamiltonian to the problem Hamiltonian. This function is called the scheduling function.

### Quantum Annealing and Adiabatic Quantum Computing (AQC):

Quantum annealing is a computation method that may be used to find a low-energy state, typically preferably the ground state, of a system. Quantum annealing is used for problems where the search space is discrete (e.g. combinatorial optimization problems) with many local minima. Similar in concept to classical annealing, the method relies on the underlying principle that natural systems tend towards lower energy states because lower energy states are more stable. However, while classical annealing uses classical thermal fluctuations to guide a system to a low-energy state and ideally its global energy minimum, quantum annealing may use quantum effects, such as quantum tunneling, to reach a global energy minimum more accurately and/or more quickly than classical annealing. In quantum annealing thermal effects and other noise may be present to aid the annealing. However, the final low-energy state may not be the global energy minimum. Adiabatic quantum computation, therefore, may be considered a special case of quantum annealing for which the system, ideally, begins and remains in its ground state throughout an adiabatic evolution. Thus, those of skill in the art will appreciate that quantum annealing systems and methods may generally be implemented on an adiabatic quantum computer. Throughout this description, any reference to quantum annealing is related to adiabatic quantum computation unless the context requires otherwise. Quantum annealing uses quantum mechanics as a source of disorder during the annealing process. The considered problem (i.e. the problem to be solved) is encoded in a Hamiltonian H_{P} and the algorithm introduces quantum effects by adding a disordering Hamiltonian H₀ that does not commute with H_{P}.

A quantum annealer is a programable quantum device that is capable of interpolating an initial Hamiltonian H₀ at time t=0 with a final or problem Hamiltonian H_{P} at a time t=T.

An appropriate design of a quantum annealer for solving the considered problem configured to produce a desired final Hamiltonian (problem Hamiltonian) comprises a tunable scheduling function.

The quantum annealer may comprise at least one scheduling function that is a time-dependent tunable parameter of the used hardware.

An optimization problem that may be solved with the present invention in particular embodiments is a mathematical problem where the idea is to find the parameters that minimize or maximize a given multivariable function, normally called the cost function.

Optimization algorithms may include simulated annealing, parallel tempering, Markov Chain Monte Carlo techniques, branch and bound algorithms, and greedy algorithms, which may be performed by a classical computer. Optimization algorithms may also include algorithms performed by a quantum computer, such as quantum annealing, quantum approximate optimization algorithm (QAOA) or other noisy intermediate-scale quantum (NISQ) algorithms, quantum implemented fault-tolerant optimization methods, or other quantum optimization algorithms.

The final Hamiltonian (also referred to here as problem Hamiltonian) is the Hamiltonian that is addressing a time t=T in adiabatic quantum computing, quantum annealing, and by quantum annealers. The ground state of this Hamiltonian codifies the solution of a considered problem such as an optimization problem.

An expectation value is the mean value obtained after an experimental measure of a physical quantity several times in a quantum experiment.

A quantum processor is a programable quantum devices composed of several informational units (qubits) that can be tuned in order to perform quantum algorithms.

The invention refers to a method that is a pulsed-analog counterdiabatic quantum computing (P-ACQC) method which is a computer-implemented method for solving a combinatorial optimization problem such as maximum independent set (MIS) problems, using an analog quantum computer.

The object of the present invention is to provide an improved means for solving a computation problem such as an optimization problem that is performed by a quantum computer.

This object is achieved by the invention.

In a first aspect, the invention refers to a method, in particular a computer-implemented method, for solving a combinatorial optimization problem.

In certain embodiments, as input, a set of time-dependent scheduling functions is provided which is used to control continuous quantum variables of quantum computers with time.

A combinatorial optimization problem that may be solved with the present invention in particular embodiments is a mathematical problem where the idea is to find the parameters that minimize or maximize a given multivariable function, called the cost function. Examples of such problems include the maximum independent set, travelling salesman problem, graph colouring, etc.

The method uses an analog quantum computer with a quantum processing unit (QPU).

In certain embodiments, the method of the invention comprises several steps.
1) In a first step, a time-dependent adiabatic Hamiltonian H_{ad}, is provided to the quantum processing unit (QPU) of the analog quantum computer.

The time-dependent adiabatic Hamiltonian H_{ad} comprises a set of time-dependent adiabatic continuous quantum variables representing Pauli X-operators, Pauli Y-operators, and Pauli Z-operators and their time-dependent coefficients

$$Pauli X : Represented as {σ}^{x} = ( \begin{matrix}0 & 1 \\ 1 & 0\end{matrix} )$$

$$Pauli Y : Represented as {σ}^{y} = ( \begin{matrix}0 & - i \\ i & 0\end{matrix} )$$

$$Pauli Z : Represented as {σ}^{Z} = ( \begin{matrix}1 & 0 \\ 0 & - 1\end{matrix} )$$

Mathematically, taking longitudinal interactions of σ^{z} between two qubits i and j as an example, a time-dependent Hamiltonian comprising these operators may be represented as:

$${H}_{ad} ( t ) = {\sum }_{i = 1}^{N} {f}_{x} ( t ) {σ}_{i}^{x} + {\sum }_{i = 1}^{N} {f}_{y} ( t ) {σ}_{i}^{y} + {\sum }_{i = 1}^{N} {f}_{z} ( t ) {σ}_{i}^{z} + {\sum }_{i < j}^{N} {f}_{zz} ( t ) {σ}_{i}^{z} {σ}_{j}^{z} \qquad ( 2 )$$

where fₓ(t), f_{y}(t), f_{z} and f_{zz}(t) are time-dependent coefficients that scale the influence of the corresponding Pauli operators at time t. These coefficients are adjusted dynamically during the quantum computation process to ensure that the system evolves adiabatically from an initial state to a final state that encodes the solution to the optimization problem.

the Pauli X-operators, Pauli Y-operators, and Pauli Z-operators and their time-dependent coefficients are controllable during the computation on the analog quantum computer. “Controllable” in this context means adjustable.

The set of time-dependent adiabatic continuous quantum variables representing Pauli X-operators, Y-operators, and Z-operators and their time-dependent coefficients represent adiabatic scheduling functions, which are used to control the QPU by evolving the time-dependent adiabatic Hamiltonian H_{ad} from an initial time (at the beginning of computation) to a final time of computation.

The ground state of the time-dependent adiabatic Hamiltonian H_{ad}(t) at the final time of the computation H_{ad}(t=T) encodes the solution to the combinatorial optimization.

The final evolution time is the time when the adiabatic evolution is complete.
2) In a second step, one-body counterdiabatic (CD) terms

$${A}^{y} = {\sum }_{i = 1}^{N} {α}^{y} ( t ) {σ}_{i}^{y}$$

are calculated.

In certain embodiments, the one-body counterdiabatic (CD) terms A^{y} satisfies being an approximate adiabatic gauge potential of the adiabatic Hamiltonian H_{ad}(t), and comprises a Pauli Y-operator on qubit i and its time-dependent coefficient α^{y}(t)

The time-dependent coefficient α^{y}(t) acts as a part of the additional term that helps maintain the adiabatic evolution.
3) In a third step, the one-body counterdiabatic (CD) terms A^{y} are added to the adiabatic Hamiltonian H_{ad}, so that the summation of the adiabatic Hamiltonian H_{ad} and one-body counterdiabatic (CD) terms A^{y} comprises quantum Pauli X-operators, Y-operators, and Z-operators and coefficients of the Pauli X-operators, Y-operators, and Z-operators.

The addition of the one-body counterdiabatic (CD) terms A^{y} to the adiabatic Hamiltonian H_{ad}, is performed such that the summation of the adiabatic Hamiltonian H_{ad} and one-body counterdiabatic (CD) terms A^{y} comprises quantum Pauli X-operators, Y-operators, and Z-operators and coefficients of the Pauli X-operators, Y-operators, and Z-operators.

Mathematically, if H_{ad}, comprises terms involving the Pauli operators with their respective coefficients, the augmented Hamiltonian can be represented as:

$${H}^{t o t a l} = {H}_{ad} + {A}^{y} = {\sum }_{i = 1}^{N} {f}_{x} ( t ) {σ}_{i}^{x} + {\sum }_{i = 1}^{N} {f}_{y}^{C D} ( t ) {σ}_{i}^{y} + {\sum }_{i = 1}^{N} {f}_{z} ( t ) {σ}_{i}^{z} + {\sum }_{i < j}^{N} {f}_{zz} ( t ) {σ}_{i}^{z} {σ}_{j}^{z} \qquad ( 3 )$$

where fₓ(t),

$${f}_{y}^{C D} ( t ) ,$$

f_{z} and f_{zz}(t) are the coefficients of the Pauli operators and

$${f}_{y}^{CD} ( t ) = {f}_{y} ( t ) + {α}^{y} ( t ) .$$

The next step is to implement H^{total} on the QPU of the analog quantum computer. The control parameters (such as microwave or laser pulses) are adjusted to reflect both the adiabatic Hamiltonian and the additional CD terms.
4) In a next step, a sequence of laser pulses is calculated to realize the summation of the adiabatic Hamiltonian H_{ad} and the one-body counterdiabatic (CD) terms A^{y}.

A sequence pulse of a coupling laser is calculated to realize the summation of the adiabatic Hamiltonian H_{ad} and its one-body counterdiabatic (CD) terms A^{y} using a central processing unit (CPU). This CPU can be directly connected to the QPU or not. If it is not directly connected, the result of the calculation is provided to the QPU through any means known in the art. The result of the calculation of the sequence of laser pulses is received by the QPU of the analog quantum computer for performing further steps of the method. The QPU controls the time-dependent continuous quantum variables of the analog quantum computer.

In certain embodiments of the method, the laser pulses include the form of
(1) a pulse X comprising a Pauli X-operator and its coefficient, and/or
(2) a pulse Y comprising a Pauli Y-operator and its coefficient, and/or
(3) a pulse Z comprising a Pauli Z-operator and its coefficient.

In certain embodiments of the method, a sequence of laser pulses, each corresponding to one of the Pauli operators and modulated by a coefficient (reflecting intensity, phase, etc.) is calculated. These pulses realize the combination (H_{ad}+A^{y}) to control the quantum state's evolution.

In particular, the coefficients of the Pauli X-operators, Pauli Y-operators, and Pauli Z-operators are the coefficients of the summation of the adiabatic Hamiltonian and its one-body counterdiabatic (CD) terms.
5) In another step, the sequence of laser pulses (as time-dependent digital blocks) is used to replace a set of adiabatic continuous quantum variables on the QPU of the analog quantum computer (fₓ(t), f_{y}(t), f_{z} and f_{zz}(t)) to evolve the analog quantum computer with time in a counterdiabatic manner to reach the ground state of the adiabatic Hamiltonian H_{ad}.

Digital signals are discretized into distinct steps or blocks. The sequence of laser pulses is implemented as time-dependent digital blocks so that they can be precisely timed and calibrated to affect the quantum state in very specific ways, enabling fine-tuned control over the system's evolution.

The replacement procedure involves mapping the smooth, continuous evolution dictated by the adiabatic and counterdiabatic Hamiltonians of an analog quantum system onto a sequence of discrete, time-dependent digital laser pulses. Mathematically, this is achieved by dividing the evolution into short time intervals Δt, within which the system's evolution due to a constant effective Hamiltonian Un≈exp (−i(H_{ad}+A^{y})Δt).

A set of adiabatic continuous quantum variables represents the parameters in the Hamiltonian of an analog quantum system that change smoothly over time to guide the system through its evolution. These variables can include external field strengths, interaction strengths between qubits, or other parameters that define the Hamiltonian. Their purpose is to ensure that the quantum system evolves along a path that keeps it in its ground state, in accordance with the adiabatic theorem, which requires that changes in the Hamiltonian occur slowly compared to the system's internal dynamics.

The ground state of the adiabatic Hamiltonian, H_{ad}, is reached at the end of the evolution process, assuming the evolution was conducted slowly enough (adiabatically) or through appropriate counterdiabatic driving to maintain the system in its instantaneous ground state despite a faster evolution.
6) In a next step, the ground state of the evolved adiabatic Hamiltonian H_{ad}(t=T), is obtained. This may be done by measuring the quantum system to directly observe its state, in particular to confirm its alignment with the ground state.

The ground state of the evolved adiabatic Hamiltonian at the final time of the computation H_{ad}(t=T) encodes the solution to the combinatorial optimization problem.

In certain embodiments of the method, the sequence of laser pulses is calculated based on different adiabatic Hamiltonians of the analog quantum computer. Different adiabatic Hamiltonians are based on how they encode the parameters of the computational problem at various stages of the solution process or based on analog quantum computers with different qubits, such as for the Ground-Rydberg qubits, the adiabatic Hamiltonian is in the format of the Eq. (2), and for trapped ions qubits, its adiabatic Hamiltonian can be written as

$${H}_{ad} ( t ) = {\sum }_{i = 1}^{N} {f}_{x} ( t ) {σ}_{i}^{x} + {\sum }_{i = 1}^{N} {f}_{y} ( t ) {σ}_{i}^{y} + {\sum }_{i < j}^{N} {f}_{x x} ( t ) {σ}_{i}^{x} {σ}_{j}^{x} . \qquad ( 4 )$$

The different adiabatic Hamiltonians of the analog quantum computer represent various stages or configurations of a computational problem, each configured to guide the quantum computer through a specific part of the computational process towards solving the given problem.

In certain embodiments, the calculation comprises steps (1) to (3) described below.
(1) Firstly, a pattern is chosen of the laser pulses X, Y and/or defined by the Pauli X-operator, Y-operator and/or Z-operator, respectively, taking into account that within certain embodiments wherein the pulse X and pulse Y cannot be on at the same time, while the pulse Z can be kept on during the whole computation. The Hamiltonian may be expressed as:

$$H ( t ) = {f}_{x} ( t ) {σ}_{x} + {f}_{y} ( t ) {σ}_{y} + {f}_{z} ( t ) {σ}_{z} \qquad ( 5 )$$

where the functions fₓ(t) f_{y}(t) and f_{z}(t) control the intensity and timing of the respective pulses, and the Pauli matrices σₓ, σ_{y} and σ_{z} define the specific quantum operations applied to the quantum computer.
(2) Secondly, a duration of each alternating pulse X and pulse Y is chosen based on a total duration of the sequence of laser pulses to be within the operational time period of the analog quantum computer while ensuring that each pulse is included at least once within the permissible duration allowing for each pulse to be present at least once within the sequence.

Let T represent the total operational time-period available. The durations of pulses X and Y can be represented as dx and dy, respectively. The sequence must satisfy:

$$d x + d y \leq T \qquad ( 6 )$$

And, considering dz for Pulse Z, though it can be continuous, we ensure dx+dy+dz≤T for any explicit Z pulses within the sequence. If nₓ, n_{y} and n_{z} represent the number of times each pulse type is applied (assuming at least once), the condition becomes:

$${n}_{x} \cdot dx + {n}_{y} \cdot dy + {n}_{z} \cdot dz \leq T \qquad ( 7 )$$

with nₓ, n_{y}≥1 ensuring each pulse type is included at least once.
(3) Thirdly, the time-dependent coefficient of each laser pulse X, Y and/or Z is set to be the same as the coefficient of the Pauli X-operator, Pauli Y-operator and/or Pauli Z-operator, respectively of the summation of the adiabatic Hamiltonian H_{ad} and the one-body counterdiabatic (CD) terms within a time interval at which the laser pulse appears in the sequence.

In certain embodiments of the method of the invention, the one-body counterdiabatic (CD) terms

$${A}^{y} = {\sum }_{i = 1}^{N} {α}^{y} ( t ) {σ}_{i}^{y}$$

are calculated as being an approximate adiabatic gauge potential of the adiabatic Hamiltonian H_{ad}.

An approximate adiabatic gauge potential is defined as a term introduced to approximate the counterdiabatic driving that would be necessary for adiabatic evolution without requiring the system to evolve slowly, thus allowing for faster quantum operations while minimizing transitions to non-desired states.

In particular, the counterdiabatic (CD) coefficients α^{y}(t) are calculated by being the solution to minimizing the action S=Tr[G²] where G=∂ₜH_{ad}(t)−i[H_{ad},A^{y}],

wherein S represents the action, a functional to be minimized, where Tr[ ] denotes the trace operation, H_{ad}(t) represents the adiabatic Hamiltonian of the system, A^{y} is the approximate adiabatic gauge potential, and G is the deviation from the ideal adiabatic evolution due to the applied counterdiabatic driving.

In certain embodiments of the method of the invention, the time dependent scheduling function with which the system changes from the initial Hamiltonian to the problem Hamiltonian comprises at least one one-body CD term for adding an approximate adiabatic gauge potential that counters the excitations arising from the non-adiabatic time evolution. In certain embodiments of the method of the invention, at least one one-body CD term is created. In certain embodiments of the method of the invention, the summation of adiabatic Hamiltonian and its one-body CD term is realized by applying a sequence of pulses on the analog quantum computer.

In certain embodiments of the method of the invention, it comprises the step of optimizing
the number of pulses,
the ratio of X and Y pulses, and/or
the duration of each pulse,

using a classical optimizer.

This optimization is performed in a central processing unit (CPU) of the hardware of the analog quantum computer. In the apparatus, the CPU is connected to a quantum processing unit (QPU), for example, as further described below with reference to FIG. 10.

The term optimizing refers to refers to the systematic adjustment and selection of various parameters to achieve the best possible performance according to predefined criteria or objectives. The optimization is performed by using classical optimization algorithms that iteratively adjust the parameters based on the evaluation of the objective function, which quantifies the performance of a given set of parameters. It is done by selecting key parameters (number of pulses, their ratio, and duration), choosing a classical optimization algorithm (such as Cobyla, Gradient descent, Newton's method, etc.), and iteratively adjusting these parameters to maximize efficiency and accuracy, converging on an optimal solution through evaluation and refinement.

In certain embodiments of the method of the invention, the time-dependent adiabatic Hamiltonian H_{ad} is an Ising Hamiltonian.

The Ising Hamiltonian may have the following form:

$${H}_{Ryd} = Ω ( t ) {\sum }_{i} {σ}_{i}^{x} - Δ ( t ) {\sum }_{i} {n}_{i} + {\sum }_{i , j} {J}_{i j} {n}_{i} {n}_{j} \qquad ( 8 )$$

wherein

$${n}_{i} = ( 1 - {σ}_{i}^{z} ) / 2$$

is the number operator, i and j are the indices for the qubits used,

Ω(t) is the Rabi frequency, which is controlled on the analog quantum computer by controlling the power of a coupling laser,

Δ corresponds to the detuning with regards to the two-photon transition and can also easily be changed dynamically, and

the term containing Jᵢⱼ is the interactions term implemented via a Rydberg blockade mechanism and is optionally rendered site-dependent or dynamically tunable.

A coupling laser, also referred to in here simply as laser, is a laser that is used to facilitate the interaction between different qubits by inducing coherent transitions between them. In certain embodiments, the power of the laser is used to control the Rabi frequency, the wavelength of the laser is used to control the detuning, and the phase of the laser is used to control the phase.

The Rabi frequency of a coupling laser is directly proportional to the square root of the laser's power (P), mathematically described as Ω(t)∝√P indicating that increasing the laser power leads to a higher rate of oscillation between quantum states.

In certain embodiments of the method of the invention, the evolution of the adiabatic Hamiltonian is adiabatic. The evolution is performed as slow as possible and the computation time is limited by the coherence time of the system which does not allow a complete adiabatic evolution.

In certain embodiments of the method of the invention, the analog quantum computer has a neutral hardware. In particular the neutral atom hardware is chosen from the group consisting of neutral atoms and trapped ions.

Neutral atoms are a type of quantum computing hardware where a certain number (N) of atoms, which have no net electric charge, are manipulated and controlled to perform quantum operations. These atoms are typically trapped and isolated using optical or magnetic fields, and their quantum states (such as energy levels or spin states) are precisely controlled using laser cooling and optical tweezers.

Trapped ions a type of quantum computing hardware where charged atoms are confined and manipulated in electromagnetic traps, such as Paul or Penning traps, which use electric or magnetic fields to hold ions in place. In quantum computing, these ions act as qubits, with quantum information encoded in their internal states, such as electronic energy levels or spin states. Lasers or microwave radiation are used to manipulate these states, enabling the implementation of quantum gates and operations.

In certain embodiments of the method of the invention, a time dependent scheduling function is used which is configured to evolve the time-dependent adiabatic Hamiltonian H_{ad} (i.e. the initial Hamiltonian) to the problem Hamiltonian at the end of the evolution. In particular, the time dependent scheduling function comprises a one-body CD term for adding an effective gauge potential that counters excitations arising from a non-adiabatic time evolution.

A time dependent scheduling function is defined as a function that controls the evolution of the Hamiltonian from an initial (in particular easily prepared) ground state (the initial Hamiltonian) to the final Hamiltonian that encodes the solution to the problem of interest over the course of the computation.

In certain embodiments, the time dependent scheduling function comprises at least one one-body CD term for adding an effective gauge potential that counters excitations arising from a non-adiabatic time evolution.

In certain embodiments of the method of the invention, the method is implemented on analog hardware using digital pulses or time dependent pulses superimposed on a native analog block of the hardware.

In this context, superimposing means applying additional control signals (in the form of digital or time-dependent pulses) on top of the ongoing analog signals that typically control the QPU's evolution.

A native analog block of the hardware refers to the fundamental, continuous-time control mechanism inherent to the quantum computing device, designed to manipulate the quantum states adiabatically.

In this context, if the hardware is governed by a time-dependent Hamiltonian H_{ad} and we superimpose digital or time-dependent pulses represented by Hₚᵤₗₛₑ, the total Hamiltonian driving the system becomes:

$${H}_{p u l s e} ( t ) = {H}_{ad} ( t ) + {H}_{C D} ( t ) , \qquad ( 9 )$$

In certain embodiments, the duration of the pulses has been adapted to maximize the results of the quantum computation, such as the success probability or the approximation ratio.

In this context maximization is the optimization procedure that refers to adjusting the duration of the pulses to optimize certain desired outcomes. Mathematically, one can denote the success probability as P and the approximation ratio as R. The pulse durations can be represented as D=d₁, d₂ . . . dₙ, where dᵢ is the duration of the iₜₕ pulse. The optimization problem can be expressed as: max D{P,R}

The invention also refers to hardware and to a quantum computer on which the method of the invention has been performed.

In certain embodiments of the method of the invention, control signals are used to manipulate, in particular to adjust the analog quantum computer.

In this context, the control signals are control pulses used to manipulate (adjust) the state of a quantum computer. Manipulating quantum states is essential for performing quantum computations. It occurs within the hardware of the quantum computer, where control signals interact directly with the qubits.

For example, in a two-level quantum system (qubit), a control signal in the form of a microwave pulse might be used to induce Rabi oscillations between the ground state |0> and the excited state |1>. The Hamiltonian for this interaction, using the Rabi frequency Ω, is:

$${H}_{i n t} ( t ) = Ω ( t ) ( \vert 1 〉 〈 0 \vert + \vert 0 〉 〈 1 \vert ) \qquad ( 10 )$$

Control signals are typically required to have a certain sequence, which is a specific arrangement of pulses and their timings to achieve a particular quantum operation or sequence of operations. Mathematically, a sequence of control signals u(t₁), u(t₂) . . . u(tₙ) would be applied at times t₁, t₂ . . . tₙ where each u(tₖ), specifies the control settings at time tₖ.

Control signals are required to have a certain sequence in certain embodiments.

In particular, the control signals are used to drive one or more (coupling) lasers to output light pulses on the analog quantum computer.

Control signals are used to precisely modulate the output of coupling lasers, directing light pulses to interact with and manipulate qubits within an analog quantum computer.

In another embodiment, the invention refers to a method, in particular a computer-implemented method, for solving an optimization problem, wherein the optimization algorithm is a constrained algorithm configured to avoid that the updated parameters surpass the experimental capabilities of the quantum device.

In another aspect, the invention refers to a use of the method described herein in quantum chemistry, quantum finance, or quantum machine learning.

In a second aspect, the invention refers to a data processing apparatus or device or system comprising means for carrying out (the steps of) the method of the invention as described herein.

In certain embodiments, the invention refers to a system for performing a method described herein, comprising a quantum processor, and a memory to save the results of the measurements of expectation values of a final Hamiltonian.

In certain embodiments, the invention refers to a computation device comprising: an interface for communicating with a quantum-processing unit; and one or more processors configured to perform the method described herein using the quantum processor.

In certain embodiments, the invention refers to a computation device comprising: an interface for communicating with a quantum-processing unit; and one or more processors configured to perform the aforementioned method using the quantum-processing unit.

In a third aspect, the invention refers to a computer program (product) comprising instructions which, when the program is executed by a computer, cause the computer to carry out (the steps of) the method of the invention as described herein.

In certain embodiments, the invention refers to a computer program having a program code for performing the method described, when the computer program is executed on a computer, a processor, a quantum-processing unit and/or a programmable hardware component.

In a fourth aspect, the invention refers to a computer-readable (storage) medium comprising instructions which, when executed by a computer, cause the computer to carry out (the steps of) the method of the invention as described herein.

In certain embodiments, the invention refers to the use of a Rydberg state for quantum computation with neutral atoms.

Other features and advantages of the invention will be apparent upon reading the detailed description and reviewing the accompanying drawings of the figures.

In certain embodiments, the invention is used in chemistry to solve optimization problems. Such chemical optimization problems may be optimization problems for finding the ground state (the lowest energy state) of a chemical molecule.

An arbitrary time-dependent scheduling function is a general solution of choosing a scheduling function, without the idea of optimization. The time-dependent scheduling function can be (1) any arbitrary function which only needs to fulfill the initial (t=0) and final (t=T) boundary conditions; and (2) accessible to be a smooth time-dependent function (for example avoiding a sudden dump during the time evolution).

The computer-implemented method for solving a computation problem, in particular for solving combinatorial optimization problem, comprises the use of an Ising spin-glass Hamiltonian in the form

$$\frac{{H}_{R y d} ( t )}{ℏ} = \frac{Ω ( t )}{2} {\sum }_{i} \{ cos [ ϕ ( t ) ] {σ}_{i}^{x} - sin [ ϕ ( t ) ] {σ}_{i}^{y} \} - Δ ( t ) {\sum }_{i} {n}_{i} + {\sum }_{i , j} {J}_{ij} {n}_{i} {n}_{j} \qquad ( 11 )$$

wherein

$${n}_{i} = ( 1 - {σ}_{i}^{z} ) / 2 ,$$

Ω is the Rabi frequency of the transition and can be dynamically controlled by controlling the power of one of the coupling laser, Δ corresponds to the detuning with regards to the two-photon transition and can also easily be changed dynamically, φ is the phase of the driving field and only the relative phase between applied pulses matters for the axis of rotation, and the term containing J_{i,j} is the interactions term implemented via a Rydberg blockade mechanism and can optionally be rendered site-dependent or can be dynamically tuned, wherein the problem is solved by finding the solution for the Hamiltonian.

In another embodiment, the invention refers to a method, in particular a computer-implemented method, for solving an optimization problem, comprising the step of providing a quantum processor with tunable or untunable coupling for encoding an optimization problem.

Tunable parameters of the schedule function may be the coupling laser power, the coupling laser phase, the coupling laser wavelength.

The parametrization of at least one given scheduling function into tunable parameters leads to the fixation of random initial values for each parameter, and the fixation of the running time (according to the coherence time) of the quantum processor that is used in the method.

In certain embodiments of the method, the quantum annealer is provided for running on a quantum computer (quantum processor) with tunable or untunable coupling.

Quantum computers (quantum processors) may include quantum annealing processors, digitized quantum processors, gate-based processors, or adiabatic quantum computation.

In certain embodiments, the invention refers to a method for solving a considered problem, comprising the step of using an arbitrary number of qubits in a quantum processor device with tunable or untunable coupling for adiabatically encoding a considered problem, in particular wherein a time dependent Hamiltonian which at time zero is given by an initial Hamiltonian is at a final time given by the final or problem Hamiltonian.

An arbitrary number of qubits refers to any integer value of qubits. The minimum number of qubits is 1. In certain embodiments, the number of qubits is between 1 and 1000. In other embodiments, the number of qubits may be between 1 and 100.

According to the description, it will be apparent to the ones skilled in the art that the scope of the invention encompasses any embodiment thereof, which is disclosed herein, irrespective of whether this embodiment is implemented independently or in concert with any other embodiment of the invention. For example, the method disclosed herein may be implemented in practice by using any numbers of the embodiments provided herein. Furthermore, it will be understood that any embodiment of the invention may be implemented using one or more of the elements presented in the appended claims.

### FIGURES

Various embodiments of the invention are further described in more detail with reference to the accompanying drawings. However, the invention may be embodied in many other forms and should not be construed as limited to any certain structure or function discussed in the following description.

The figures show:

FIG. 1 An example of a 3 qubit graph. The ideal ground state of the final Hamiltonian H_{Ryd}(t_{f}) encodes the MIS solution |101>.

FIG. 2: The schematic diagram of a digital-analog counterdiabatic quantum computing algorithm.

FIG. 3: The coupling field of the system with the effective control hx(x) of σ^{x} term and the CD coefficient α_{y}(t) of σ^{y} term.

FIG. 4: The detuning of the coupling field Δ(t)/Δ₀ as a function of instantaneous computation time.

FIG. 5: The population of |101> state as a function of processing time t for a 3 qubits example in FIG. 1. The comparison is between (1) without CD protocol (blue dotted line), DACQC protocol with 4 pulses (τ_{X+Z}, τ_{Y+Z}, τ_{X+Z}, and τ_{Y+Z}) to realize one-body CD term (red solid line). Parameters are Δ₀/Ω₀=6, J/Ω₀=4, total computation time TΩ₀=0.8.

FIG. 6: The control fields as a function of time during one computation on an emulator of a neutral atom quantum computer: Here are the plotted Rabi frequency and detuning as normalized by their maximum values for a total computational time of 1.1 μs.

FIG. 7: The control fields as a function of time during one computation on an emulator of a neutral atom quantum computer: Here is plotted the phase as normalized by its maximum value for a total computational time of 1.1 μs.

FIG. 8: Success probability obtained from both methods, Adiabatic Quantum Computation (AQC) and the pulsed-Analog Counterdiabatic Quantum Computation (p-ACQC), compared for different graphs and with different times of computation.

FIG. 9: Drawing of the graphs for which the MIS problem was solved using the AQC or p-ACQC method.

FIG. 10: Apparatus (100) for performing a method for solving a combinatorial optimization problem involving analog counterdiabatic quantum computing (ACQC).

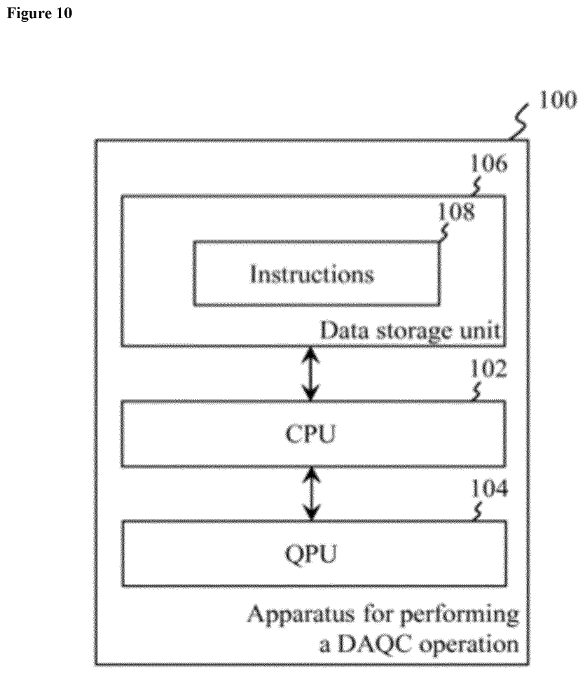

As shown in FIG. 10, the apparatus 100 comprises a central processing unit (CPU) 102, a quantum processing unit (QPU) 104, and a data storage unit 106. The QPU 104 is connected to the CPU 102. The data storage unit 106 is connected to the CPU 102 and stores processor-executable instructions 108. Being executed by the CPU 102, the processor-executable instructions 108 cause the CPU 102 to implement aspects of the present invention.

The number, arrangement, and interconnection of the constructive elements constituting the apparatus 100, which are shown in FIG. 10, are not intended to be any limitation of the present invention, but merely used to provide a general idea and example of how the constructive elements may be implemented within the apparatus 100. For example, each of the CPU 102 and the QPU 104 may be replaced with several corresponding processing units, as well as the data storage unit 106 may be replaced with several removable and/or fixed storage devices, depending on particular applications. Furthermore, the apparatus 100 may further comprise a transceiving unit (not shown) which, for example, may be configured to receive the processor-executable instructions 108 from a remote server and store them to the data storage unit 106 before the operation of the apparatus 100, as well as transmit the operation results of the apparatus 100 to the remote server.

The CPU 102 may be implemented as a general-purpose processor, single-purpose processor, microcontroller, microprocessor, application specific integrated circuit (ASIC), field programmable gate array (FPGA), digital signal processor (DSP), complex programmable logic device, or alike. The CPU 102 may be implemented as any combination of one or more of the aforesaid. As an example, the CPU 102 may be a combination of two or more microprocessors.

The QPU 104 may refer to a physical or simulated processor that contains a number of interconnected qubits. In this sense, the QPU 104 serves as a quantum information storage device. The QPU 104 may include a single quantum processor, or two or more quantum processors, and may be based on Rydberg atoms held by optical tweezers in vacuum.

The data storage unit 106 may be implemented as a classical nonvolatile or volatile memory used in the modern electronic computing machines. As an example, the nonvolatile memory may include Read-Only Memory (ROM), ferroelectric Random-Access Memory (RAM), Programmable ROM (PROM), Electrically Erasable PROM (EEPROM), solid state drive (SSD), flash memory, magnetic disk storage (such as hard drives and magnetic tapes), optical disc storage (such as CD, DVD and Bluray discs), etc. As for the volatile memory, examples include Dynamic RAM, Synchronous DRAM (SDRAM), Double Data Rate SDRAM (DDR SDRAM), Static RAM, etc.

The processor-executable instructions 108 stored in the data storage unit 106 may be configured as a computer-executable code which causes the CPU 102 to implement the aspects of the present invention. The computer-executable code for carrying out operations or steps for the aspects of the present invention may be written in any combination of one or more programming languages, such as Java, C++, or the like. In some examples, the computer-executable code may be in the form of a high-level language or in a pre-compiled form and be generated by an interpreter (also pre-stored in the data storage unit 106).

### Examples

### Rydberg Qubits

Neutral atoms set-ups have been used for years now as a truly versatile experimental platform for quantum simulation. The shift in interest from quantum simulation to quantum computation with industrial applications in mind followed with the recent technological developments for trapping and manipulating arrays of single atoms led to the use of neutral atoms platforms to perform analog quantum computing. One of the most commonly used atomic species for quantum computation is rubidium 87 due to its very well studied electronic structure as well as the availability of the lasers and other hardware necessary to create a rubidium experiment.

Another key element to realize quantum computation with neutral atoms is the use of Rydberg states. Rydberg states are electronic states of an atom which has high quantum number, thus where the outer shell electron is promoted far away from the atomic core. This yields long range interactions with neighbouring atoms. There are different ways to exploit Rydberg states that yields different spin state mapping scheme for neutral atoms platforms.

The last crucial point is the use of optical tweezers which are far-off resonance laser beams used to trap single atoms in space and reorganize them into any 2-dimensional or 3-dimensional patterns. Cooled down atomic clouds, Rydberg states and optical tweezers constitutes the fundamental building blocks of the vast majority of neutral atoms quantum computation platforms.

A two spin states mapping scheme is presented here.

### Ground—Rydberg Mapping

An atom which outer shell electron is promoted to a Rydberg state will interact with a neighboring atom in its natural ground state through a Van der Waals interaction. This interaction creates the Rydberg blockade phenomenon which prevents two neighboring atoms to be excited both in the Rydberg state creating quantum logic which is exploited on neutral atoms platform to recreate an Ising spin-glass Hamiltonian:

$$\frac{{H}_{R y d} ( t )}{h} = \frac{Ω ( t )}{2} {\sum }_{i} \{ cos [ ϕ ( t ) ] {σ}_{i}^{x} - sin [ ϕ ( t ) ] {σ}_{i}^{y} \} - Δ ( t ) {\sum }_{i} {n}_{i} + {\sum }_{i < j} {J}_{i j} {n}_{i} {n}_{j} \qquad ( 12 )$$

where

$${n}_{i} = ( 1 - {σ}_{i}^{z} ) / 2 ,$$

σ^{x} and σ^{z} the spin states Pauli matrices. This is achieved by shining lasers coupling through a two-photon transition the electronic ground state to the Rydberg state. Here, Ω is the Rabi frequency of the transition and can be dynamically controlled by controlling the power of one of the coupling lasers, Δ corresponds to the detuning with regards to the two-photon transition and can also be changed dynamically, φ is the phase of the driving field and only the relative phase between applied pulses matters for the axis of rotation. The term containing Jᵢⱼ is the interaction term implemented via the Rydberg blockade mechanism and decays with the distance between the two interacting atoms. It can be rendered site-dependent as well as can be dynamically tuned to a certain extent.

This is the most common spin state mapping scheme used by neutral atoms hardware companies as it is one of the easiest experimentally to implement and control and because of the shape of the native Hamiltonian, Ising spin-glass, onto which many industry-relevant problems can be encoded.

### Rydberg-Rydberg Mapping

Another spin state mapping scheme relies on the use of two different Rydberg states of the same atomic species. Two neighboring atoms cannot be promoted into the same Rydberg state but can be promoted to different Rydberg states. The two far-away outer shell electrons will then interact through dipole-dipole interaction which decays with the distance between the two atoms with a different power law than the Van der Walls interaction described in the previous subsection. By mapping the spin states of the qubits onto both Rydberg states, the resulting Hamiltonian is then written as:

$${H}_{rr} = {\sum }_{i < j} {V}_{i , j} ( {σ}_{i}^{x} {σ}_{j}^{x} + {σ}_{i}^{y} {σ}_{j}^{y} ) \qquad ( 13 )$$

with σ^{x} and σ^{y} the spin states Pauli matrices and Vᵢⱼ the interaction coefficient introduced when a microwave field is turned on to couple the two Rydberg states. This Hamiltonian has the shape of a Heisenberg Hamiltonian.

### Neutral Atoms Computation

Current neutral atoms quantum computers using the Ground-Rydberg (G-R) mapping show results of computing with a typical number of qubits ranging from 200 to 400 qubits. The number of qubits may soon be increased to 1000. Those computations are performed in the framework of adiabatic computation; the next section will give context for this framework.

The main limitations of the G-R mapping are the lifetime of the Rydberg state used as one of the spin states which is approximately 30 μs. This time is not enough to be able to perform a real adiabatic computation and results in a lot of noise in the results. As for other platforms, the way to allow those computation to find the solutions is through variational methods and a high number of repetitions of the experiment to get the solution statistically.

We present here one example of such methods used to compute the solution of the maximum independent set problems, a combinatorial optimization problem which shape is ideal to benchmark neutral atoms quantum computers against.

The results of the computation of the MIS problem on a Ground-Rydberg mapped neutral atoms computers with up to 289 qubits has been shown. To improve the results limited by the coherence time, they leverage two variational methods commonly used in quantum computing problems, the quantum approximate optimization algorithm (QAOA) and variational quantum adiabatic algorithm (VQAA). The first method, QAOA, is used to parametrize a series of resonant laser pulses, coupling the two spin states, which effectively realizes the evolution of the many-body Hamiltonian. By finding variationally an optimal ensemble of parameters for those pulses, the probability of reaching the desired state corresponding to the solution of the problem was enhanced. For the second method, VQAA, the continuous function controlling the dynamically tunable parameters of the Hamiltonian was split into a segment that are variationally optimized to increase the probability of finding the desired state corresponding to the solution of the problem.

The results obtained constitute one of the best promising results for quantum computation with neutral atoms, but the methods used are at the current time limited by the available coherence time of the qubits. Additionally, with the increase of the system size the variational part of the algorithm becomes extremely time costly.

The method of the invention is able to tackle problems with higher number of qubits and circumvent the limitation of the coherence time by reducing the computation time for each repetition.

### Manning and Adiabatic Framework

The framework used to compute problems onto an analog quantum computer is the adiabatic framework and quantum annealing. For adiabatic quantum computing, one starts from a Hamiltonian which has a trivial ground state and evolves the system towards a Hamiltonian which has the solution of the computation problem as its ground state. The evolution should be adiabatic which yields very long computation times. This is limited by the coherence time of the system which does not allow complete adiabatic evolution. In the case of neutral hardware, the computation of combinatorial optimization can only be done with a non-adiabatic evolution between the initial Hamiltonian and the problem (the final) Hamiltonian. This leads to possible excitations in the energy spectrum and can yield the wrong final state, in other words the wrong solution of the problem. To circumvent that one can try optimizing the time dependent function with which the system changes from the initial Hamiltonian to the problem Hamiltonian. This function is called the scheduling function.

### Introducing a Counterdiabatic Protocol

Counterdiabatic (CD) protocols aim to increase the energy gap between quantum states and prevent transitions while speeding up the adiabatic quantum computation, thus allowing for good results for systems where the adiabatic time is long in regards with the coherent time of the system or the experimentally available time of computation. This stems from adding an effective gauge potential that will counter the excitations due to the non-adiabatic time.

One way to recreate an approximate gauge potential is by using a one-body CD term. This method greatly improves the results of computation for short time allowing the system to find the right solution statistically. The downside of this method is the difficulty of its implementation on neutral atom systems as it requires the addition of interactions in the system which are not native.

CD protocols are implemented using the one-body local and/or global CD term which is an approximation of the one-body CD term. The CD term implementation is realized by applying a digital-analog approach, constituting of digital gates superimposed by analog blocks. The novelty of this invention is to use the digital-analog approach to realize one-body local and/or global CD terms.

Digital-Analog Approach Realizing One-Body Local and/or Global CD Term

The digital-analog approach relies on a combination of analog blocks and digital gates applied to a given systems.

An analog block refers to the continuous evolution of a physical system such as the electrical quantities in an electric circuit, hydraulic quantities in a network of tubes or the wavefunction of a quantum mechanical system. In the early stages of classical computing, entire analog computers were built to simulate and analyze complex mechanical systems by realizing an electrical equivalent and studying its evolution. However, analog approaches are constructed to solve very specific problems.

In classical computing, the development of precise and cheap integrated electronics and micro-processors allowed building of the more versatile digital computers based on implementing digital representation of values and applying digital logic gates. Most quantum computing approaches use a set of discrete qubit gates to implement versatile quantum circuits. However, the precision of the digital quantum gates is still very limited compared to classical logic gates.

Due to this limitation, use a digital-analog approach was also used to realize counterdiabatic quantum computing in analogy to the classical digital-analog computers. For example, in classical analog-digital hybrids, numerical calculations were performed on digital components while complex differential equation were solved using the analog components. In the digital-analog counterdiabatic quantum computing, one-body local and/or global CD terms were realized reusing quantum gates superimposed with analog blocks given by the time evolution of the quantum system under its native interactions.

This approach is easy to implement on neutral atom systems, since laser pulses of given duration, laser intensity and phase natively serve as the digital gates and the time evolution of the neutral atom system's quantum state under its native Rydberg-Rydberg interactions realizes the analog blocks. The digital-analog counterdiabatic implementation allows to speed up the quantum computing process and simultaneously increases the process fidelity.

### Pulsed-Analog Counterdiabatic Quantum Computing (P-ACQC)

The Hamiltonian of neutral atoms platforms using Ground-Rydberg mapping reads:

$${H}_{Ryd} ( t ) = {H}_{drive} + {H}_{int} \qquad ( 14 )$$

the target ground state of the final Hamiltonian encodes the solution to the computation problem, which provides the final constraints for the driving field.

Adiabatic computing is a known tool to solve optimization problems whose solutions are encoded to be the ground state of the problem Hamiltonian H_{Ryd}(T)=Hₚ. By choosing an initial Hamiltonian H_{Ryd}(0) for which the corresponding ground state is known, the adiabatic process can ensure that one evolves the system from initial H(0) to the final H(T) by slowly changing the driving variables while fulfilling the boundary conditions for t=0 and t=T, which means that the wave function of the system |ψ(t) [symbol] follows the instantaneous eigenstates of Hamiltonian |n(t) [symbol] , so that the final state of the system is the target ground state of the problem Hamiltonian Hₚ.

Instead of an adiabatic evolution, the counterdiabatic (CD) evolution is implemented allowing evolution times shorter than the system's coherence time and preventing excitations to states with larger energy than the ground state of the problem Hamiltonian.

Then, following the typical counterdiabatic (CD) approach, the total Hamiltonian is

$$H ( t ) = {H}_{Ryd} + {H}_{C D} \qquad ( 15 )$$

For example, this method can be used to solve combinatorial optimization problems on a neutral atoms platform, such as a Maximal independent set (MIS). MIS is a combinatorial optimization problem consisting of a graph of vertices connected by edges and for which the solution is the graph containing the maximum number of colored vertices without having two colored vertices connected by an edge. In the following, a CD protocol is provided based on a digital-analog approach, and a MIS problem is used as an example.

$$\frac{{H}_{R y d} ( t )}{h} = \frac{Ω ( t )}{2} {\sum }_{i} \{ cos [ ϕ ( t ) ] {σ}_{i}^{x} - sin [ ϕ ( t ) ] {σ}_{i}^{y} \} - Δ ( t ) {\sum }_{i} {n}_{i} + {\sum }_{i < j} {J}_{i , j} {n}_{i} {n}_{j} , \qquad ( 16 )$$

Where the first term is H_{drive} and the last term is Hᵢₙₜ, Ω(t) is the Rabi frequency of the two photons transition, Δ(t) is the detuning of the two photon transitions, φ(t) is the laser phase, and

$${n}_{i} = ( 1 - {σ}_{i}^{Z} ) / 2.$$

The target ground state of final Hamiltonian encodes the solution to the combinatorial optimization problem, which provides the final constraints for the effective control field Ω(T) and Δ(T). As an example, ℏ=1 and is used in the rest of the description.

### One-Body CD Term Protocol

To circumvent the complexity of the additional two or more body interacting terms because of the limitation of experiment implementation, the simple one-body CD form of N-qubit system is

$${H}_{C D} = ( \dot{Ω} Δ - \dot{Δ} Ω ) {A}^{y} , \qquad ( 17 )$$

wherein

$${A}^{y} = {\sum }_{i = 1}^{N} {α}_{i}^{y} ( t ) {σ}_{i}^{y} , \qquad ( 18 )$$

with local coefficients

$${α}_{i}^{y} ( t )$$

which can be solved by being the solution to minimize the action of S as follows

$$S = Tr [ {G}^{2} ] , \qquad ( 19 )$$

wherein

$$G = M - i ( \dot{Ω} Δ - \dot{Δ} Ω ) [ H , {A}^{y} ] , \qquad ( 20 )$$

where M=Ω∂_{Ω}H_{Ryd}+Δ∂_{Δ}H_{Ryd}, i is the imaginary unit and the dot represents the derivative with respect to time.

The results can be further improved by adding a layer of optimization on the scheduling function (optimal control theory, variational protocols . . . ). Moreover, if the σ^{y} term is limited by experiment which means that only one global control variable α^{y} is realizable in experiment platform, then this one-body term is consider to provide a valid improvement for a short computation time. Certainly, if the local control is realizable experimentally, one can also push further by implementing different local parameters

$${σ}_{i}^{y}$$

terms for each qubit that will further enhance the results.

### Pulsed-Analog One-Body CD Term Protocol:

The one-body CD term is implemented using a pulsed-analog approach. The one-body CD term has the form of

$${H}_{C D} ∝ {\sum }_{i} {σ}_{i}^{y} . \qquad ( 21 )$$

One sees that the Hamiltonian of the full system in Eq. (16) contains terms of

$${σ}_{i}^{y}$$

which one can use by adjusting the relative phase φ(t) accordingly. Instead of shining a laser continuously at the atoms, laser pulses are applied of given phase φ. The phase φ is the relative phase of the laser pulses and these pulses can be designed to be constant to build time-independent digital blocks, or these pulses can be time-dependent to be directly implement on an analog quantum computer.

For constant global Rabi frequencies Ω(t)=Ω, constant detunings Δ(t)=Δ, and choosing φ=0, φ=π, φ=π/2, and φ=3π/2 one obtains the Hamiltonians of the digital blocks

$${H}_{X + Z} = {\sum }_{i} \frac{Ω}{2} {σ}_{i}^{x} - {\sum }_{i} Δ {n}_{i} , \qquad ( 22 )$$

$${H}_{- X + Z} = {\sum }_{i} - \frac{Ω}{2} {σ}_{i}^{x} - {\sum }_{i} Δ {n}_{i} , \qquad ( 23 )$$

$${H}_{Y + Z} = {\sum }_{i} \frac{Ω}{2} {σ}_{i}^{y} - {\sum }_{i} Δ {n}_{i} , \qquad ( 24 )$$

$${H}_{- Y + Z} = {\sum }_{i} - \frac{Ω}{2} {σ}_{i}^{y} - {\sum }_{i} Δ {n}_{i} , \qquad ( 25 )$$

respectively. The analog block is given by Hᵢₙₜ=Σ_{i<j}J_{i,j}nᵢnⱼ of Eq. (16). In the following, the inventors give an example of the system's time evolution for the duration τ of the digital block H_{X+Z}

$$U ( τ ) = exp [ - \frac{i}{ℏ} ( {H}_{X + Z} + {H}_{i n t} ) τ ] , \qquad ( 26 )$$

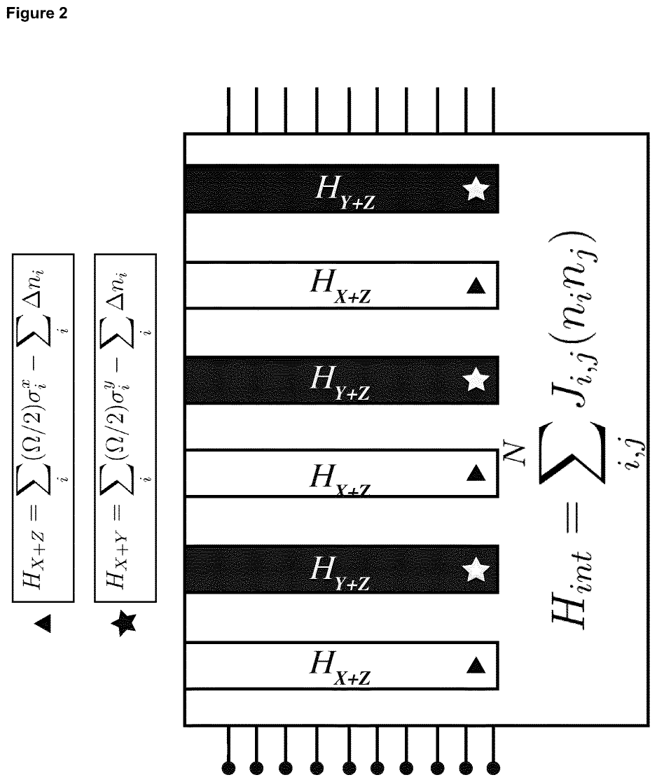

which is the evolution of the digital block superimposed with the analog block. FIG. 2 shows an example of a full digital-analog CD protocol. The protocol is built from the different digital blocks superimposed with the analog block. The H_{Y+Z} and H_{-Y+Z} blocks realize the one-body CD terms and are surrounded by H_{X+Z} and H_{-X+Z} blocks. The system evolves under the digital blocks plus the all-times-on native interaction Hᵢₙₜ.

The digital-analog CD protocol was generalized to Rabi frequencies and detuning that are varying with time. For this case, the full Hamiltonians of the digital blocks [Eqs. (22(25)] are time dependent and this protocol is named pulsed analog counterdiabatic quantum computing or p-ACQC. Here the laser pulse durations are τ_{X+Z}, τ_{-X+Z}, τ_{Y+Z}, and τ_{-Y+Z}, corresponding to the durations of the digital blocks, resulting in the time evolutions

$${U}_{X + Z} ( {τ}_{X + Z} ) = exp [ - \frac{i}{ℏ} {\int }_{{t}_{0}}^{{τ}_{X + Z}} ( {\sum }_{i} \frac{Ω ( t )}{2} {σ}_{i}^{x} - {\sum }_{i} Δ ( t ) {n}_{i} ) d t - \frac{i}{ℏ} {τ}_{X + Z} {H}_{i n t} ] , \qquad ( 27 )$$

$${U}_{- X + Z} ( {τ}_{- X + Z} ) = exp [ + \frac{i}{ℏ} {\int }_{{t}_{0}}^{{τ}_{- X + Z}} ( {\sum }_{i} \frac{Ω ( t )}{2} {σ}_{i}^{x} - {\sum }_{i} Δ ( t ) {n}_{i} ) d t - \frac{i}{ℏ} {τ}_{- X + Z} {H}_{i n t} ] , \qquad ( 28 )$$

$${U}_{Y + Z} ( {τ}_{Y + Z} ) = exp [ - \frac{i}{ℏ} {\int }_{{t}_{0}}^{{τ}_{Y + Z}} ( {\sum }_{i} \frac{Ω ( t )}{2} {σ}_{i}^{y} - {\sum }_{i} Δ ( t ) {n}_{i} ) d t - \frac{i}{ℏ} {τ}_{Y + Z} {H}_{i n t} ] , \qquad ( 29 )$$

$${U}_{- Y + Z} ( {τ}_{- Y + Z} ) = exp [ + \frac{i}{ℏ} {\int }_{{t}_{0}}^{{τ}_{- Y + Z}} ( {\sum }_{i} \frac{Ω ( t )}{2} {σ}_{i}^{y} - {\sum }_{i} Δ ( t ) {n}_{i} ) d t - \frac{i}{ℏ} {τ}_{- Y + Z} {H}_{i n t} ] . \qquad ( 30 )$$

A further generalization includes atom position dependent Rabi frequencies Ωᵢ(t) and atom position dependent detunings Δᵢ(t). The position dependent Rabi frequencies allow to implement one-body local CD terms and the position dependent detunings can enable solving weighted Maximum independent set problems.

### Optimizing the Time Dependent Function Used for the y Pulses

By changing the phase, it is possible to implement the one body CD term on a neutral atom hardware. The calculation of the one body CD has been previously explained. In certain embodiments, the counterdiabatic properties of the addition of the CD term is improved by optimizing the time dependent CD coefficient. The Rabi frequency during the Y+Z pulses is then optimized to maximize the success probability, the probability to obtain the ground state of the final Hamiltonian by performing one computation. One can use a classical optimizer for every problem tackled and create new Rabi frequency time dependent controls for every graph problem solved. One can create a more general Rabi frequency time dependent control by optimizing on several graphs at once and output one time dependent control for all. One can also train a machine-learning model to create a Rabi frequency time dependent control for any graph based on properties of the graph. One can also add the number of pulses and the ratio between the duration of the X+Z (U_{X+Z}(τ_{X+Z})) and Y+Z (U_{Y+Z}(τ_{Y+Z})) laser pulses as free parameters to optimize, on top of the time dependent control of the Rabi frequency during the Y+Z pulses, to maximize success probability.

### Data Obtained Using a Digital-Analog CD Protocol

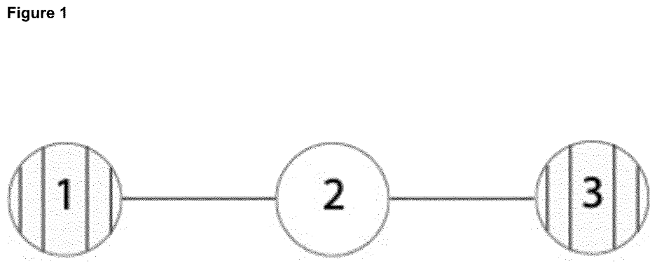

Examples of combinatorial optimization problems, in particular Maximal independent set (MIS) of N-atoms system are shown in the figures. Simple toy models of 3 qubit systems are used, see FIG. 1.

By applying a CD protocol for the following form of adiabatic Hamiltonian Hₐ(t)=(1−λ(t))Hᵢ+λ(t)Hₚ, the ansatz of the control variables is provided as

$$Ω ( t ) = {Ω}_{0} ( 1 - λ ( t ) ) , and Δ ( t ) = {Δ}_{0} λ ( t ) , \qquad ( 31 )$$

where Ω₀ and Δ₀ are the maximum value of the experimental Rabi frequency and the detuning, respectively. Then the Hamiltonian in Eq. (16) becomes

$${H}_{Ryd} = {Ω}_{0} ( 1 - λ ) {\sum }_{i} {σ}_{i}^{x} - {Δ}_{0} λ {\sum }_{i} {n}_{i} + J ( {n}_{1} {n}_{2} + {n}_{2} {n}_{3} ) , \qquad ( 32 )$$

where λ is a time-dependent scheduling function which fulfils the boundary conditions λ(0)=0 and λ(t_{f})=1. In this case, the initial state for one to prepare should be the ground state of

$${H}_{Ryd} ( 0 ) = {Ω}_{0} {Σ}_{i} {σ}_{i}^{x} + J ( {n}_{1} {n}_{2} + {n}_{2} {n}_{3} ) .$$

The initial ground state can be solved numerically, for example J=4, |Ω(0) [symbol] =|−0.5231631732824501, 0.45105747137515934, 0.33446499190807844, −0.1336991966412011, 0.45105747137515934, −0.40928419192378085, −0.1336991966412011, 0.06529378391970472) in the basis of bit string. To guarantee the ground state of the Hamiltonian being the MIS solution, the constraint of parameters in this embodiment is

$${Δ}_{0} < 2 J . \qquad ( 33 )$$

Taking the following example of the scheduling function

$$λ ( t ) = s i {n}^{2} [ \frac{π}{2} s i {n}^{2} ( \frac{π t}{2 {t}_{f}} ) ] , \qquad ( 34 )$$

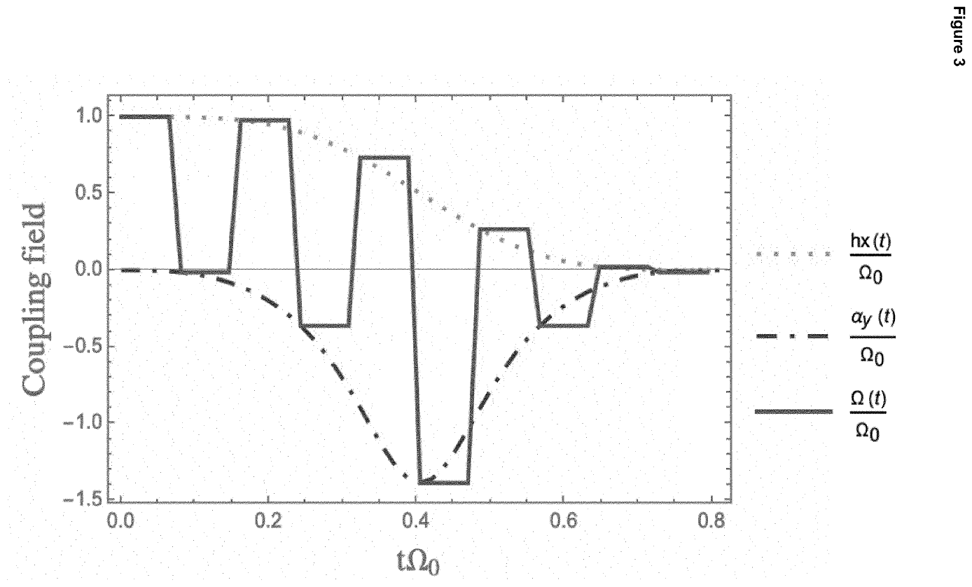

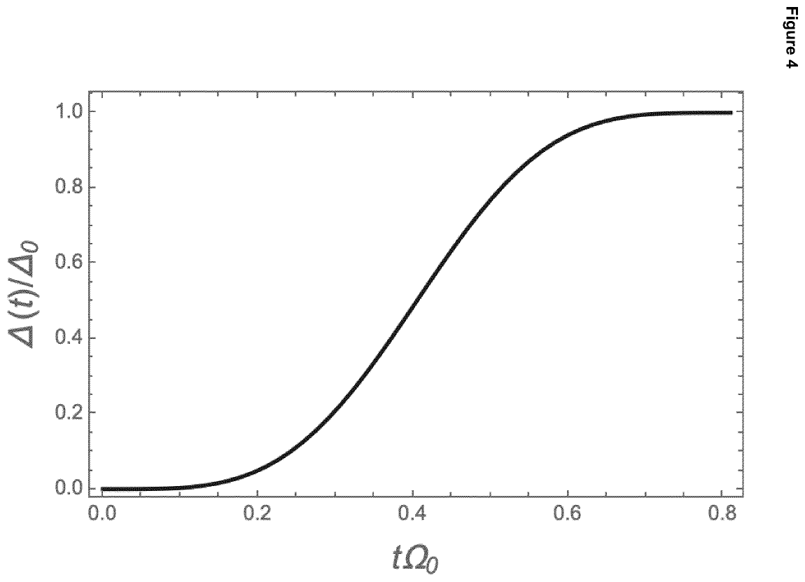

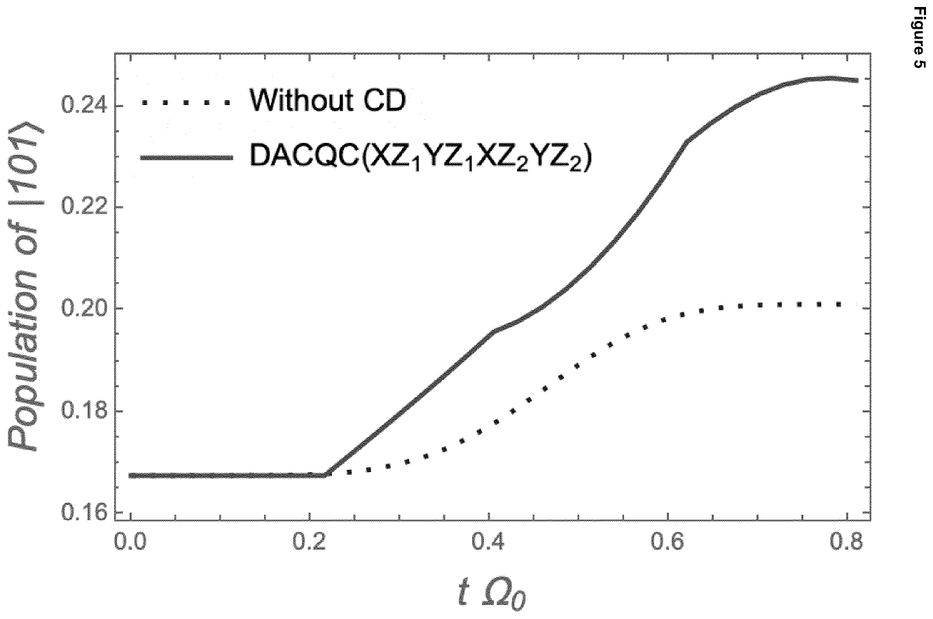

the control variables Ω(t) and Δ(t) are plotted as a function of time in FIG. 3 and FIG. 4. In FIG. 5, the instantaneous population of MIS solution |101 [symbol] is plotted as a function of time for 3 qubit system in FIG. 1. Comparing with the time evolution without CD term, the simulation of the DACQC protocol with 4 pulses (τ_{X+Z}, τ_{Y+Z}, τ_{X+Z}, and τ_{Y+Z}) to realize one-body CD term shows enhancement.
Data Obtained with Pulsed Analog Counterdiabatic Quantum Computing Protocol

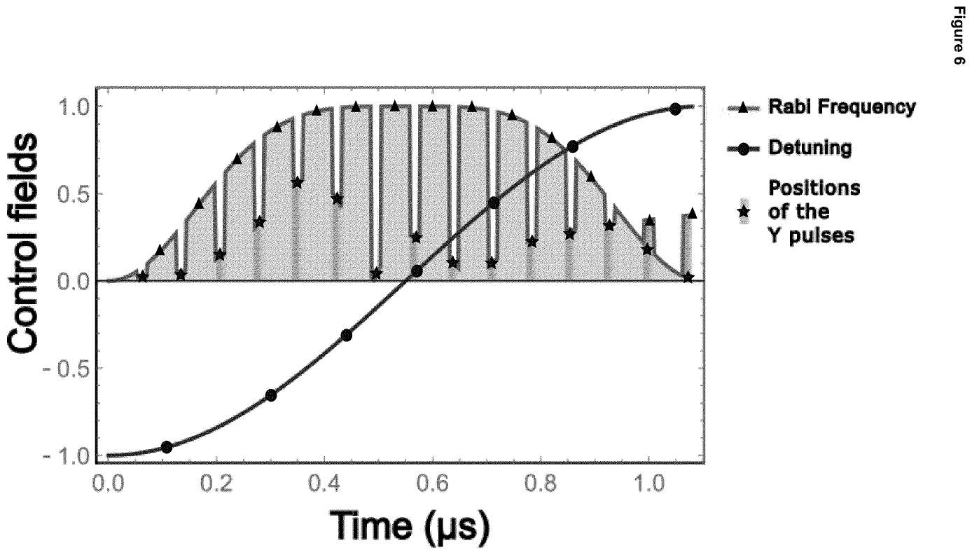

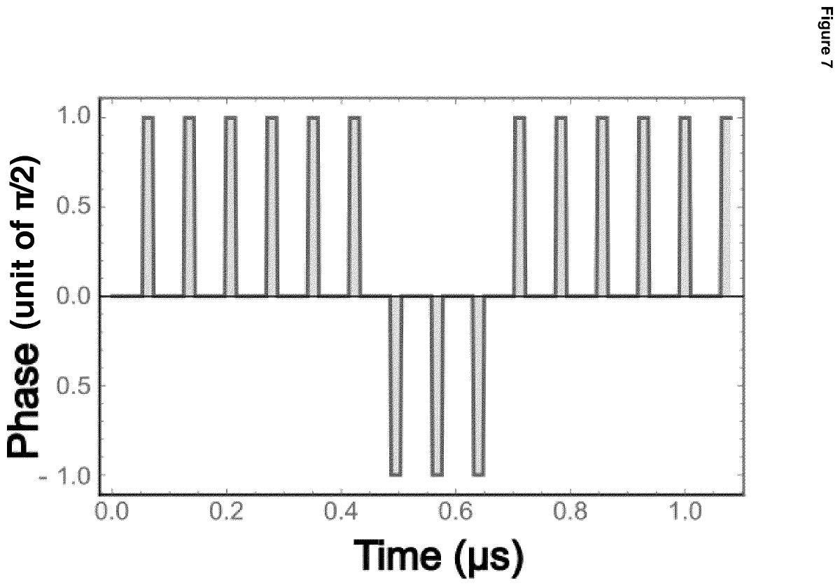

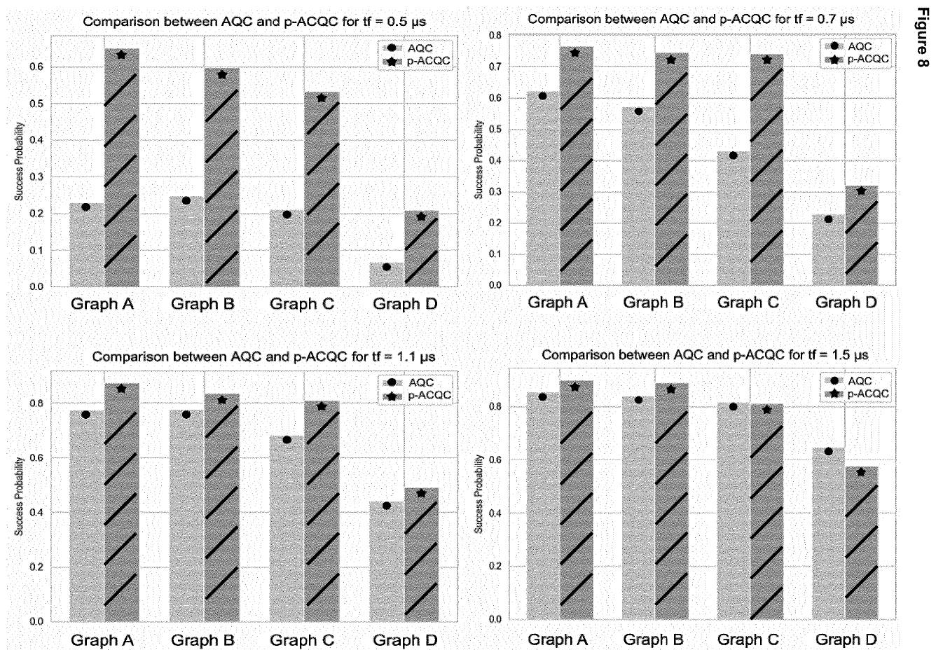

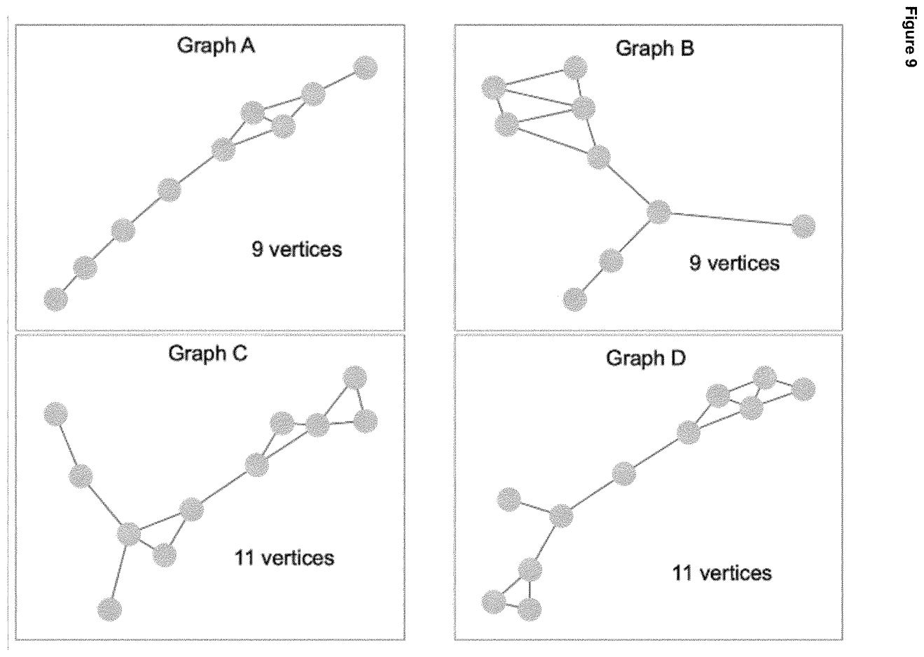

For this example, the Maximum Independent Set problem was solved on 4 graphs labeled A, B, C and D as shown in FIG. 9 by using the adiabatic quantum computing framework on an emulated neutral atom quantum computer. The inventors compare two methods, the traditional Adiabatic Quantum Computing (AQC) and our digital-analog counterdiabatic method in the case of time dependent control of the Rabi frequency and detuning during each pulse, named accordingly pulsed Analog Counterdiabatic Quantum Computing (p-ACQC). The computation starts with the initial ground state of Rydberg Hamiltonian |(0 [symbol] ^{⊗N} (N is the number of qubits). The control fields which represent the pulses are represented in FIG. 6 and FIG. 7 for one computation with a total computational time of 1.1 μs. The FIG. 7 shows the phase shift representing the different combination of pulses X+Z and Y+Z, and the FIG. 6 shows the time dependent Rabi frequency and detuning with the position of the Y+Z pulses marked. The time dependent control has been chosen through a classical optimizer, optimizing the Rabi Frequency during the Y+Z pulses. The optimization has been performed on all graphs at once, maximizing the minimum of the success probability obtained on every graph with a set of free parameters. The number of pulses and the ratio of the duration of the X+Z and Y+Z pulses have been also optimized in the same manner. The inventors performed the optimization for all different final times of computation used. The results are then represented on FIG. 8 where is shown the success probability, so the probability of finding the solution of the Max Independent Set problem encoded in the final state of the system by performing one computation, for all 4 graphs comparing AQC and p-ACQC protocols for different total times of computation varying from 0.5 μs to 1.5 μs. For the shorter total times of computation, the p-ACQC protocol shows great enhancement over the AQC protocol in the success probability, and as the total time of computation increases the enhancement gets smaller as we are getting closer to an adiabatic regime.

1. A computer-implemented method for solving a combinatorial optimization problem using an analog quantum computer with a quantum processing unit, comprising:
Providing to the quantum processing unit a time-dependent adiabatic Hamiltonian H_{ad}(t),
wherein the time-dependent adiabatic Hamiltonian H_{ad}(t) comprises a set of time-dependent adiabatic continuous quantum variables representing Pauli X-operators, Y-operators, and Z-operators and their time-dependent coefficients;
wherein a ground state of the time-dependent adiabatic Hamiltonian at a final time of the computation H_{ad}(t=T) encodes a solution to the combinatorial optimization problem;
Calculating one-body counterdiabatic terms
$${A}^{y} = {\sum }_{i = 1}^{N} {α}^{y} ( t ) {σ}_{i}^{y}$$
as being an approximate adiabatic gauge potential of the adiabatic Hamiltonian H_{ad}(t) which comprises a Pauli Y-operator
$${σ}_{i}^{y}$$
on qubit i and its time-dependent counterdiabatic coefficient α^{y}(t);
Adding the one-body counterdiabatic terms A^{y} to the adiabatic Hamiltonian H_{ad}(t), so that the summation of the adiabatic Hamiltonian H_{ad}(t) and one-body counterdiabatic terms A^{y} comprises quantum Pauli X-operators, Y-operators, and Z-operators and coefficients of the Pauli X-operators, Y-operators, and Z-operators;
Using a central processing unit to calculate a sequence of pulses of a laser to realize the summation of the adiabatic Hamiltonian H_{ad}(t) and its one-body counterdiabatic terms A^{y} and providing it to the quantum processing unit,
wherein the laser pulses include the form of:
a pulse X comprising a Pauli X-operator and its coefficient, or
a pulse Y comprising a Pauli Y-operator and its coefficient, or
a pulse Z comprising a Pauli Z-operator and its coefficient, and
wherein the coefficients of the Pauli X-operators, Y-operators, and Z-operators are the coefficients of a summation of the adiabatic Hamiltonian and its one-body counterdiabatic terms,
Using the sequence of laser pulses to replace the set of adiabatic continuous quantum variables of the analog quantum computer to evolve the analog quantum computer with time in a counterdiabatic manner to reach the ground state of the adiabatic Hamiltonian at the final time of the computation H_{ad}(t=T), and
Obtaining the ground state of the time-dependent adiabatic Hamiltonian at the final time of the computation H_{ad}(t=T), which encodes the solution to the combinatorial optimization problem.

2. The method of claim 1, wherein the sequence of laser pulses is calculated based on the adiabatic Hamiltonian H_{ad} of the analog quantum computer, the calculation comprising:
choosing a pattern of at least one of the laser pulses X, Y and Z defined by at least one of the Pauli X-operator, Y-operator and Z-operator, wherein the pulse X and pulse Y cannot be on at the same time, while the pulse Z can be on consistently,
choosing a duration of each alternating pulse X and pulse Y based on a total duration of the sequence of laser pulses to be within an operational time period of the analog quantum computer, wherein each pulse is included at least once in the sequence, and
setting the time-dependent coefficient of at least one of each laser pulse X, Y and Z to be the same as the coefficient of at least one of the Pauli operator X-operator, Y-operator and Z-operator, respectively of the summation of the adiabatic Hamiltonian H_{ad} and the one-body counterdiabatic terms within a time interval at which the laser pulse appears in the sequence.

3. The method of claim 1, wherein the one-body counterdiabatic terms
$${A}^{y} = {\sum }_{i = 1}^{N} {α}^{y} ( t ) {σ}_{i}^{y}$$
are calculated as being an approximate adiabatic gauge potential of the adiabatic Hamiltonian H_{ad}.

4. The method of claim 1, comprising optimizing at least one of:
the number of pulses,
the ratio of X and Y pulses, and
the duration of each pulse,
using a classical optimizer.

5. The method of claim 1, wherein the time-dependent adiabatic Hamiltonian H_{ad} is an Ising Hamiltonian in the form
$${H}_{R y d} = Ω ( t ) {\sum }_{i} {σ}_{i}^{x} - Δ ( t ) {\sum }_{i} {n}_{i} + {\sum }_{i , j} {J}_{i j} {n}_{i} {n}_{j}$$
wherein
$${n}_{i} = ( 1 - {σ}_{i}^{z} ) / 2$$
is the number operator, i and j are the indices for the qubits,
Ω(t) is a Rabi frequency, which is controlled on the analog quantum computer by controlling the power of a (coupling) laser,
Δ corresponds to a detuning with regards to a two-photon transition and can also easily be changed dynamically, and
the term containing Jᵢⱼ is the interaction between qubit i and j implemented via a Rydberg blockade mechanism.

6. The method of claim 1, wherein the evolution of the adiabatic Hamiltonian is adiabatic.

7. The method of claim 1, wherein the analog quantum computer is chosen from the group consisting of neutral atoms and trapped ions.

8. The method of claim 1, wherein a time-dependent scheduling function is used which is configured to evolve the time-dependent adiabatic Hamiltonian H_{ad} from an initial time to a problem Hamiltonian which is the time-dependent Hamiltonian at the end of computation, wherein the time dependent scheduling function comprises a one-body counterdiabatic term for adding an approximate gauge potential that counters excitations arising from a non-adiabatic time evolution.

9. The method of claim 1, implemented on analog hardware using digital pulses or time dependent pulses superimposed on a native analog block of the hardware.

10. The method of claim 1, wherein digital or time-dependent pulses are used as control signals to control the time evolution of the analog quantum computer.

11. A data processing system comprising means for carrying out the method of claim 1.

12. A computer program product comprising instructions which, when the program is executed by a computer, cause the computer to carry out the method of claim 1.

13. A non-transitory computer-readable storage medium comprising instructions which, when executed by a computer, cause the computer to carry out the method of claim 1.

14. The method of claim 3, wherein the counterdiabatic coefficients α^{y}(t) are calculated by being the solution to minimizing the action S=Tr[G²] where G=∂ₜH_{ad}(t)−i[H_{ad},A^{y}],
wherein S represents the action, a functional to be minimized, where Tr[ ] denotes a trace operation, H_{ad}(t) represents the adiabatic Hamiltonian of the system, A^{y} is the approximate adiabatic gauge potential, and G is a deviation from an ideal adiabatic evolution due to the applied counterdiabatic driving.

15. The method of claim 5, wherein the term containing Jᵢⱼ is rendered site-dependent or dynamically tunable.

16. The method of claim 10, wherein the control signals are used to drive one or more lasers to output light pulses on the analog quantum computer.
